(19) United States
(12) Patent Application Publication
(10) Pub. No.: US 2008/0135369 A1
(43) Pub. Date: Jun. 12, 2008

(54) STAMPED CLUTCH POCKET PLATE, METHOD FOR MAKING THE POCKET PLATE, AND CLUTCH INCLUDING THE POCKET PLATE

(75) Inventor: Thomas Meier, Rochester Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: MEANS INDUSTRIES, INC., Saginaw, MI (US)

(21) Appl. No.: 11/943,020

(22) Filed: Nov. 20, 2007

Related U.S. Application Data
(60) Provisional application No. 60/873,143, filed on Dec. 6, 2006.

(51) Int. Cl. F16D 13/64; B21D 28/02

(52) U.S. Cl. 192/107 R; 72/362

(57) ABSTRACT

A one-way clutch (20) includes a notch plate (22), and a stamped pocket plate (24) having an annular flange (38) and a splined axial sleeve (40). Semi-pierced strut pockets (44) are stamped in the annular flange (38) of the pocket plate (24) and each includes a stamped spring pocket (46) for receiving an associated spring (28) that biases a strut (26) received within the strut pocket. Holes (48ᵢ) are initially stamped in the annular flange 38 and the spring pockets (46) are then stamped thereabout prior to the semi-piercing of the strut pockets (44). Semi-pierced pads (50) in the annular flange (38) alternate circumferentially with the strut pockets (44).

### CROSS-REFERENCE TO RELATED APPLICATIONS

This invention claims the benefit of U.S. provisional patent application Ser. No. 60/873,143 filed on Dec. 6, 2006 under the title of METHOD AND APPARATUS FOR MAKING CLUTCH POCKET PLATE AND RESULTANT PRODUCT.

### BACKGROUND OF THE INVENTION

1. Field of the Invention

This invention relates to: a stamped clutch pocket plate; a method for making the pocket plate; and a one-way clutch including the pocket plate.

2. Background Art

One type of one-way clutches such as disclosed by U.S. Pat. No. 6,193,038 includes struts that are received within respective strut pockets in an annular pocket plate and spring biased outwardly toward an adjacent annular notch plate to permit relative rotation of the pocket plate and notch plate with respect to each other in one direction about a central axis while preventing rotation thereabout in the opposite direction. Such pocket plates are conventionally made from powdered metal to provide the required strut pockets for receiving the struts and associated biasing springs.

### SUMMARY OF THE INVENTION

One object of the present invention is to provide an improved clutch pocket plate.

In carrying out the above object, the clutch pocket plate of the invention is stamped with a one-piece construction and includes an annular flange that extends radially with respect to a central axis and a sleeve that extends axially from the annular flange and has axial splines. Semi-pierced strut pockets are stamped in the annular flange spaced circumferentially from each other and extend axially while remaining integrally connected thereto with a unitary construction. Each strut pocket includes a stamped spring pocket having an inner extremity including a stamped hole.

As disclosed, the strut pockets have T shapes, and each T-shaped strut pocket includes a circumferentially extending stem and a branch that extends radially from the stem and opens in a radially outward direction. A groove extends adjacent each strut pocket.

A groove extends adjacent each strut pocket, and each strut pocket having a T shape including a circumferentially extending stem and a branch that extends radially from the stem and opens in a radial outward direction. Also, the spring pocket of each strut pocket has a round inwardly tapering shape.

The stamped one-piece clutch pocket plate as disclosed includes semi-pierced pads stamped in the annular flange extending axially therefrom in the same direction as the strut pockets. The strut pockets and the pads alternate with each other circumferentially about the annular flange, and each pad has a generally trapezoidal shape including curved inner and outer radial extremities and radially inwardly converging circumferential extremities.

Thus, the stamped one-piece clutch pocket plate as disclosed has a groove that extends adjacent each strut pocket, with each strut pocket having a T shape including a circumferentially extending stem and a branch that extends radially from the stem and opens in a radial outward direction, with each spring pocket of each clutch pocket having a round inwardly tapering shape, and with semi-pierced pads stamped in the annular flange extending axially therefrom in the same direction as the strut pockets and spaced circumferentially about the annular flange in an alternating relationship with the strut pockets.

Another object of the present invention is to provide an improved method for making a one-way clutch pocket plate.

In carrying the immediately preceding object, the method for making a one-piece clutch pocket plate in accordance with the invention is performed by stamping a blank to include an annular flange that extends radially with respect to a central axis and to include a sleeve that extends axially from the annular flange and has axial splines. Holes are stamped through the annular flange spaced circumferentially around the central axis from each other. Spring pockets are stamped around the holes with depths that are less than the axial thickness of the annular flange along the central axis and the annular flange remains flat while the holes through the flange are decreased in size. Strut pockets are stamped in a semi-piercing manner around the spring pockets in the annular flange and project axially therefrom while remaining integrally connected thereto with a unitary construction.

As disclosed, the spring pockets are stamped with round inwardly tapering shapes and the strut pockets are stamped with T shapes. Also, the T-shaped strut pockets are each stamped to include a circumferentially extending stem and a branch that extends radially from the stem and opens in a radially outward direction, and the strut pockets are stamped with a groove extending adjacent each strut pocket.

Thus, the method as disclosed is performed by stamping a groove adjacent each strut pocket and with each strut pocket having a T shape including a circumferentially extending stem and a branch that extends radially from the stem and opens in a radially outward direction.

As disclosed, the annular flange is also stamped with semi-pierced pads that extend axially therefrom in the same direction as the pocket struts. Furthermore, the pads and pocket struts are stamped in a circumferentially alternating relationship in the annular flange, and the pads are each stamped with a generally trapezoidal shape including curved inner and outer radial extremities and radially inwardly converging circumferential extremities.

Thus, the method for making a one-piece clutch pocket plate is performed by stamping a groove extending adjacent each strut pocket with each strut pocket having a T shape including a circumferentially extending stem and a branch that extends radially from the stem and opens in a radially outward direction, with the annular flange also stamped with semi-pierced pads that extend axially therefrom in the same direction as the strut pockets, and with the strut pockets and the pads stamped in a circumferentially alternating relationship with each other around the annular flange.

Another object of the present invention is to provide an improved one-way clutch.

In carrying out the immediately preceding object, the one-way clutch of the invention has a central axis and includes an annular notch plate that extends around the central axis and has notches spaced circumferentially about the central axis. A stamped one-piece clutch pocket plate of the clutch has an annular flange that opposes the spaced notches of the notch plate and extends radially with respect to the central axis. The pocket plate also has a sleeve that extends axially from the annular flange and has axial splines. Semi-pierced strut pockets of T shapes are stamped in the annular flange of the pocket plate spaced circumferentially from each other and extending axially while remaining integrally connected thereto with a unitary construction. Each strut pocket includes a stamped spring pocket having an inner extremity including a stamped hole. T-shaped struts are received within the strut pockets, and springs are received within the spring pockets and pivotally biasing the struts outwardly therefrom toward the notch plate to allow relative rotation between the notch plate and the pocket plate in one direction about the central axis but to prevent relative rotation therebetween in the other direction about the central axis.

The one-way clutch as disclosed has the annular flange of the pocket plate stamped with semi-pierced pads that extend axially therefrom in the same direction as the strut pockets and in a circumferentially alternating relationship.

The objects, features and advantages of the present invention are readily apparent from the following detailed description of the preferred embodiment when taken in connection with the accompanying drawings.

### BRIEF DESCRIPTION OF THE DRAWINGS

FIG. 1 is a half schematic view illustrating a one-way clutch that is constructed in accordance with the invention and includes an annular notch plate, a stamped one-piece clutch pocket plate, and struts biased by springs to cooperate between the notch plate and pocket plate to provide one-way clutching.

FIG. 2 is a exploded perspective view of the one-way clutch of the invention.

FIG. 3 is a perspective view illustrating the stamped clutch pocket plate from the opposite side shown in FIG. 2.

FIG. 4 is a partial view illustrating the manner in which struts of the clutch are received within strut pockets of the pocket plate and biased by a spring in an outward direction to provide the one-way clutching.

FIG. 5 is a partial enlarged view of FIG. 2 further illustrating the strut pockets of the pocket plate.

FIG. 6 is a partial enlarged view of FIG. 2 but cut away to better illustrate the manner in which the strut pockets and pads are stamped in a semi-piercing manner.

FIG. 7 is a partial axial view of the pocket plate looking generally in the direction of FIG. 2.

FIG. 8 is a schematic view illustrating a stamping system for stamping the pocket plate.

FIG. 9 is a partial sectional view illustrating the manner in which a pocket plate blank is initially stamped to provide a through hole that ultimately becomes part of the strut pocket.

FIG. 10 is a partial view illustrating the manner in which a spring pocket is stamped in the blank about the through hole whose size is reduced by such stamping.

FIG. 11 is a partial view illustrating a further stamping that provides semi-piercing of the strut pocket with the spring pocket.

FIG. 12 is a view showing a further step where the pads are stamped in a semi-piercing manner.

### DETAILED DESCRIPTION OF THE PREFERRED EMBODIMENT

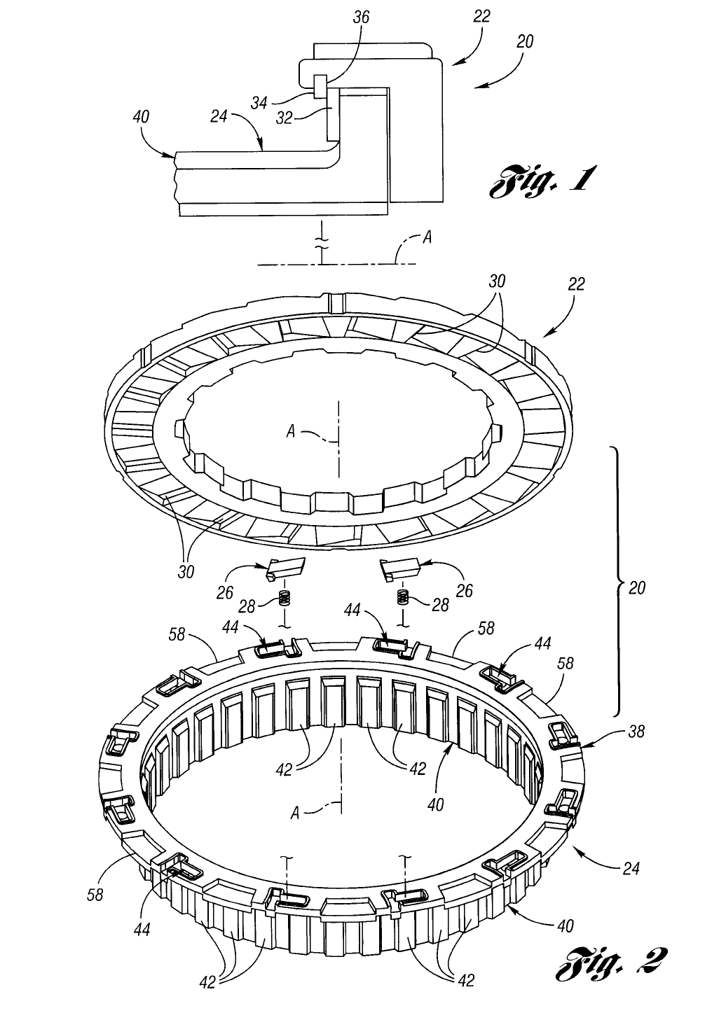

With reference to FIGS. 1 and 2 of the drawings, a one-way clutch generally indicated by 20 includes a notch plate 22 and a stamped pocket plate 24 constructed in accordance with the present invention. Struts 26 received by the pocket plate 24 are biased by springs 28 toward notches 30 of the notch plate 22 to prevent relative rotation between the notch plate and the pocket plate in one direction about a central axis A of the clutch while permitting relative rotation therebetween in the opposite direction as is hereinafter more fully described. The stamped clutch plate 24 and the method for making the clutch plate as well as the clutch 20 will be described in an integrated manner to facilitate an understanding of all aspects of the invention.

As illustrated in FIG. 1, the clutch 20 includes a thrust plate 32 that slidably contacts the pocket plate 24 and is positioned by a snap ring 34 secured in a groove 36 of the notch plate 22 to maintain the assembled condition of the clutch. Assembly of the clutch in this manner is more fully described by allowed U.S. patent application Ser. No. 11/201,482 filed on Aug. 5, 2005 by Robert T. Fetting, Jr. and Gregory M. Eisengruber under the title of Overrunning Clutch Having Snap Ring Secured Thrust Plate, the entire disclosure of which is hereby incorporated by reference.

With reference to FIGS. 2-7, the pocket plate 24 has a stamped construction including an annular flange 38 that extends radially with respect to the central axis and a sleeve 40 that extends axially from the annular flange along the central axis A and has splines 42 utilized to provide rotational positioning with respect to the mechanism with which the clutch is utilized. It should be appreciated that the splines 42 may be formed in the sleeve 40 by stamping or by other processes such as radial impacting against a toothed mandrel or rolling on a toothed mandrel between toothed dies that are moved in opposite directions and form the sleeve to the mandrel shape at diametrically opposite locations.

Semi-pierced strut pockets 44 shown in FIGS. 2-7 are stamped in the annular flange 38 of the pocket plate 24 and spaced circumferentially from each other while extending axially along the central axis A and remaining integrally connected to the annular flange with a unitary construction. Each strut pocket 44 as best shown in FIGS. 5, 6, 7 and 12 includes a spring pocket 46 having an inner extremity including a stamped hole 48. Each strut pocket 44 also has a groove 49 extending adjacent thereto generally in an outline manner slightly spaced therefrom as is hereinafter more fully described.

As best illustrated in FIG. 5, each strut pocket 44 has a generally T shape including a circumferentially extending stem 50 and a branch 52 that extends radially from the stem and opens in a radially outward direction at its outer end 54 while its inner end 56 is closed.

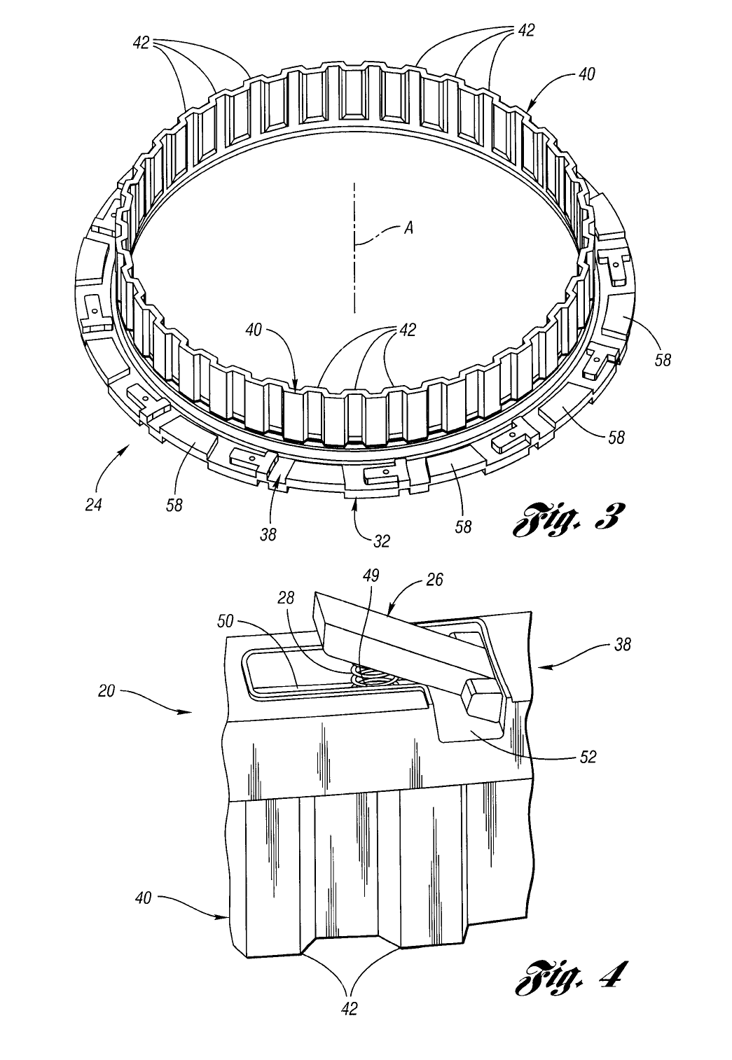

The spring pocket 46 of each strut pocket 44 receives an associated spring 28 as shown in FIGS. 2 and 4 and the associated strut 26 also has a somewhat T shape received within the T-shaped strut pocket and is biased by the spring 28 in an outward direction so as to cooperate with the notches 30 in the notch plate 22 shown in FIG. 2 in order to permit relative rotation between the notch plate and the pocket plate in one direction while preventing such rotation in the other direction. Each spring pocket 46 as best shown in FIG. 12 has an inwardly tapering shape that facilitates the receipt of the associated spring during assembly although this spring pocket can also be stamped without a taper, and the through hole 48 permits oil flow between the notch plate and the pocket plate to provide lubrication.

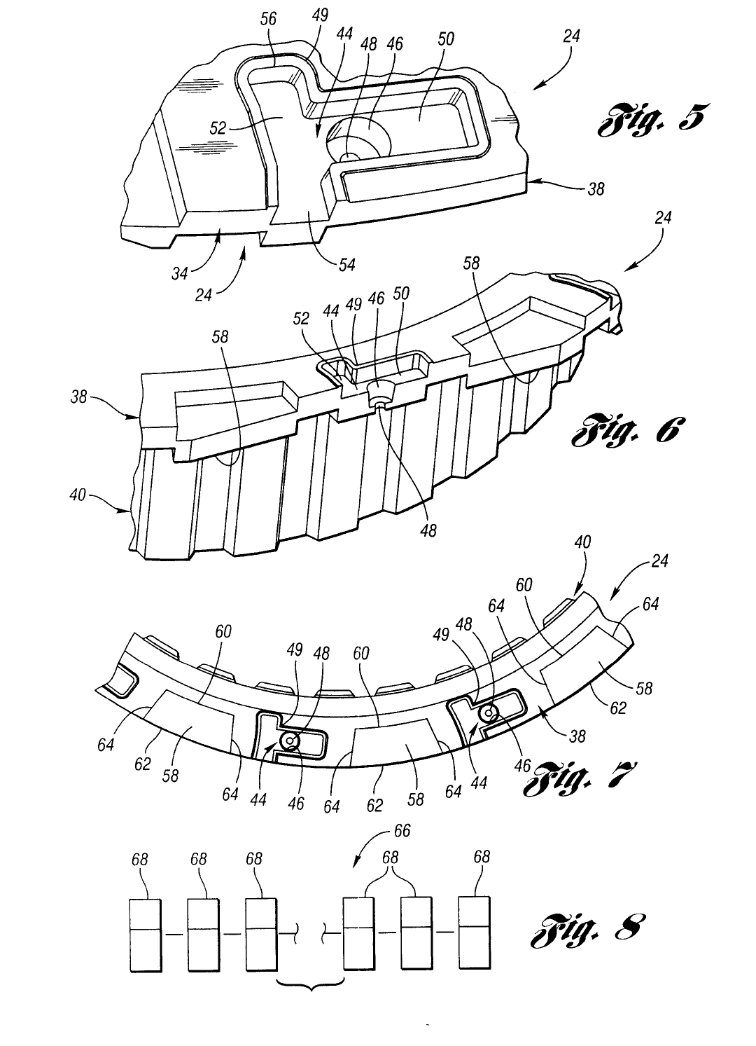

With reference to FIGS. 2, 3, 6 and 7, semi-pierced pads 58 are also stamped in the annular flange 38 of pocket plate 34 and extend axially therefrom in the same direction as the strut pockets 44. The semi-pierced pads 58 cooperate with the backsides of the strut pockets 44 so as to be slidably engaged by the thrust plate 32 (FIG. 1) of the one-way clutch. As best shown in FIG. 2, the strut pockets 44 and the pads 58 alternate with each other around the annular flange 38. Furthermore, as disclosed in FIG. 7, each semi-pierced pad 58 has a generally trapezoidal shape including curved inner and outer extremities 60 and 62, respectively, and radially inwardly converging circumferential extremities 64. However, it should be appreciated that the pads 58 may have other shapes such as round, etc.

As illustrated in FIG. 8, a stamping line 66 is of the transfer type including stamping stations 68 along which the pocket plate 24 is stamped through different operations. After each stamping cycle, the part being stamped is transferred to the next station after starting with a round blank. It should be appreciated that progressive stamping may also be utilized to provide the stamped pocket plate 24 from a strip that is moved along the stamping line from one end toward the other.

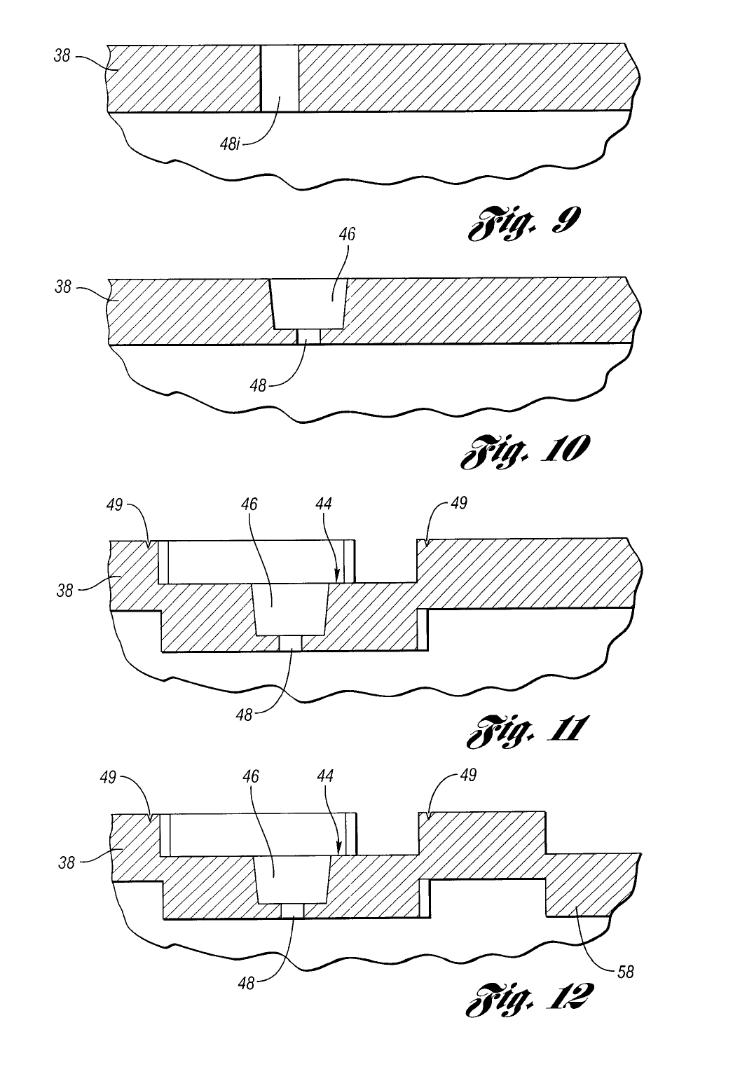

The construction of the semi-pierced strut pockets 44 and pads 58 shown in FIG. 2 begins as shown in FIG. 9 by initially stamping the annular flange 38 with the hole 48ᵢ through the part. Thereafter, the next stamping step as shown in FIG. 10 stamps the tapered spring pocket 46 around the hole 48 while the annular flange remains flat with material movement that decreases the size of the hole to provide the final hole size. Thereafter, the strut pockets 44 are semi-pierced as shown in FIG. 11 to the T shape previously described without stamping through the thickness of the annular flange. This stamping is performed with an outline perimeter die that forms the groove 49 adjacent the strut pocket 44 to permit the semi-piercing as shown while maintaining shape accuracy and squareness of the strut pocket walls. The pads 58 are then semi-pierced as shown in FIG. 12 so as to extend axially from the annular flange 38 as previously described in an alternating relationship with the strut pockets 44.

The pocket plate 24 illustrated in FIG. 2 has the axial flange 48 located at the radial inner extremity of the annular flange 38; however, in other embodiments the axial sleeve may be located at the radial outer extremity of the annular flange. Furthermore, the order in which the stamping progresses can be varied such as, for example, semi-piercing the pads 58 before the strut pockets 44 rather than after the strut pockets.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A stamped one-piece clutch pocket plate comprising:
an annular flange that extends radially with respect to a central axis and a sleeve that extends axially from the annular flange and has axial splines;
semi-pierced strut pockets stamped in the annular flange spaced circumferentially from each other and extending axially while remaining integrally connected thereto with a unitary construction; and
each strut pocket including a stamped spring pocket having an inner extremity including a stamped hole.

2. A stamped one-piece clutch pocket plate as in claim 1 wherein the strut pockets have T shapes.

3. A stamped one-piece clutch pocket plate as in claim 2 wherein each T-shaped strut pocket includes a circumferentially extending stem and a branch that extends radially from the stem and opens in a radially outward direction.

4. A stamped one-piece clutch pocket plate as in claim 1 wherein a groove extends adjacent each strut pocket.

5. A stamped one-piece clutch pocket plate as in claim 1 wherein a groove extends adjacent each strut pocket, and each strut pocket having a T shape including a circumferentially extending stem and a branch that extends radially from the stem and opens in a radial outward direction.

6. A stamped one-piece clutch pocket plate as in claim 1 wherein the spring pocket of each strut pocket has a round inwardly tapering shape.

7. A stamped one-piece clutch pocket plate as in claim 1 further including semi-pierced pads stamped in the annular flange extending axially therefrom in the same direction as the strut pockets.

8. A stamped one-piece clutch pocket plate as in claim 7 wherein the strut pockets and the pads alternate with each other circumferentially about the annular flange.

9. A stamped one-piece clutch pocket plate as in claim 7 wherein each pad has a generally trapezoidal shape including curved inner and outer radial extremities and radially inwardly converging circumferential extremities.

10. A stamped one-piece clutch pocket plate as in claim 1 wherein a groove extends adjacent each strut pocket, each strut pocket having a T shape including a circumferentially extending stem and a branch that extends radially from the stem and opens in a radial outward direction, each spring pocket of each clutch pocket having a round inwardly tapering shape, and semi-pierced pads stamped in the annular flange extending axially therefrom in the same direction as the strut pockets and spaced circumferentially about the annular flange in an alternating relationship with the strut pockets.

11. A method for making a one-piece clutch pocket plate by stamping, comprising:
stamping a blank to include an annular flange that extends radially with respect to a central axis and to include a sleeve that extends axially from the annular flange and has axial splines;
stamping holes through the annular flange spaced circumferentially around the central axis from each other;
stamping spring pockets around the holes with depths that are less than the axial thickness of the annular flange along the central axis, and with the annular flange remaining flat and the holes through the flange decreased in size; and
stamping semi-pierced strut pockets around the spring pockets in the annular flange projecting axially therefrom while remaining integrally connected thereto with a unitary construction.

12. A method for making a one-piece clutch pocket plate as in claim 11 wherein the spring pockets are stamped with round inwardly tapering shapes.

13. A method for making a one-piece clutch pocket plate as in claim 11 wherein the strut pockets are stamped with T shapes.

14. A method for making a one-piece clutch pocket plate as in claim 13 wherein the T-shaped strut pockets are each stamped to include a circumferentially extending stem and a branch that extends radially from the stem and opens in a radially outward direction.

15. A method for making a one-piece clutch pocket plate as in claim 11 wherein the strut pockets are stamped with a groove extending adjacent each strut pocket.

16. A method for making a one-piece clutch pocket plate as in claim 11 wherein the strut pockets are stamped with a groove extending adjacent each strut pocket and with each strut pocket having a T shape including a circumferentially extending stem and a branch that extends radially from the stem and opens in a radially outward direction.

17. A method for making a one-piece clutch pocket plate as in claim 11 wherein the annular flange is also stamped with semi-pierced pads that extend axially therefrom in the same direction as the strut pockets.

18. A method for making a one-piece clutch pocket plate as in claim 17 wherein the pads and pocket struts are stamped in a circumferentially alternating relationship in the annular flange.

19. A method for making a one-piece clutch pocket plate as in claim 17 wherein the pads are each stamped with a generally trapezoidal shape including curved inner and outer radial extremities and radially inwardly converging circumferential extremities.

20. A method for making a one-piece clutch pocket plate as in claim 11 wherein the strut pockets are stamped with a groove extending adjacent each strut pocket, with each strut pocket having a T shape including a circumferentially extending stem and a branch that extends radially from the stem and opens in a radially outward direction, the annular flange is also stamped with semi-pierced pads that extend axially therefrom in the same direction as the strut pockets, and the strut pockets and the pads are stamped in a circumferentially alternating relationship with each other around the annular flange.

21. A one-way clutch having a central axis and comprising:
an annular notch plate that extends around the central axis and including notches spaced circumferentially about the central axis;
a stamped one-piece clutch pocket plate having an annular flange that opposes the spaced notches of the notch plate and extends radially with respect to the central axis, and the pocket plate having a sleeve that extends axially from the annular flange and has axial splines;
semi-pierced strut pockets of T shapes stamped in the annular flange of the pocket plate spaced circumferentially from each other and extending axially while remaining integrally connected thereto with a unitary construction;
each strut pocket including a stamped spring pocket having an inner extremity including a stamped hole;
T-shaped struts received within the strut pockets; and
springs received within the spring pockets and pivotally biasing the struts outwardly therefrom toward the notch plate to allow relative rotation between the notch plate and the pocket plate in one direction about the central axis but to prevent relative rotation therebetween in the other direction about the central axis.

22. A one-way clutch as in claim 21 wherein the annular flange of the pocket plate also includes stamped semi-pierced pads that extend axially therefrom in the same direction as the strut pockets and in a circumferentially alternating relationship.
